SEQUENCE LISTING (5 sequences)

SEQ ID NO: 1 - DNA, 18 bp, Artificial
  This is an artificial PCR primer
gagcgagactccgtctca

SEQ ID NO: 2 - DNA, 21 bp, Artificial
  This is a artificial Primer sequence
tggtctcgatctcctgacctc

SEQ ID NO: 3 - DNA, 21 bp, Artificial
  Artificial Primer Sequence
tggtctcgatctcctgacctc

SEQ ID NO: 4 - DNA, 11 bp, Artificial
  Artificial Primer Sequence
tttaataaaaa

SEQ ID NO: 5 - DNA, 11 bp, artificial
  Artificial Primer Sequence
aacatcaaaat

(19) United States
(12) Patent Application Publication
(10) Pub. No.: US 2013/0040828 A1
(43) Pub. Date: Feb. 14, 2013

(54) METHOD FOR DETECTING GENE REGION FEATURES BASED ON INTER-ALU POLYMERASE CHAIN REACTION

(71) Applicants: Hong Xue, Hong Kong (CN); Lingling Mei, Hong Kong (CN)

(72) Inventors: Hong Xue, Hong Kong (CN); Lingling Mei, Hong Kong (CN)

(21) Appl. No.: 13/637,444

(22) PCT Filed: Mar. 28, 2011
(86) PCT No.: PCT/CN11/72204

§ 371 Date: Nov. 1, 2012

(30) Foreign Application Priority Data
Mar. 30, 2010 (CN) 201010139483.5

(51) Int. Cl. C40B 20/00

(52) U.S. Cl. 506/2

(57) ABSTRACT

The present invention provides a method for detecting features of genic region based on inter-Alu polymerase chain reaction using segments of the consensus sequences of Alu element family, especially the AluY subfamily, as the main oligonucleotide primers to amplify genomic DNA, followed by massively-parallel DNA sequencing of the amplicons. The features of genomic regions detected comprise single nucleotide polymorphisms (SNP), point mutations, sequence insertion/deletions (indel) and the level of DNA CpG loci methylation.

### FIELD OF TECHNOLOGY

This invention falls into the field of “Biotechnology”. Specifically, it relates to the detection of single nucleotide polymorphisms (SNP), point mutations, sequence insertion/deletions (indel) and the level of DNA CpG loci methylation in genomic regions. The method uses the consensus sequences of Alu family, especially the AluY subfamily, to design oligonucleotide primers for genomic DNA amplification. Since the amplicons generated by such inter-Alu PCR are enriched with genic sequences from the human genome, this invention enables the preferential pre-sequencing capture of genic sequences, using greatly reduced amounts of DNA sample, for massively-parallel sequencing analysis of genomic variations.

### BACKGROUND

Next-generation, massively-parallel sequencing technologies have transformed the landscape of genetics through their ability to produce giga-bases of sequence information in a single run. This technology advancement has cut down the cost of whole-genome sequencing and facilitated the study on disease etiologies. It has been widely employed for disease-association studies including cancer and psychiatric disorders. However, its demand for large amounts of DNA sample remains a major drawback. In most instances the use of even 3 micrograms of genomic DNA for analysis would still fall short of the stringent requirements of whole-genome sequencing, giving useful data on some genomic regions only and missing out on other regions. From the Human Genome Project, we know that protein encoding regions and whole genic regions only account for 1% and 25% of the human genome respectively. It therefore yields only very limited amounts of useful sequence data for disease-association genic studies. There thus exists in current DNA sequencing methodologies an imbalance between high cost and limited yield of useful data.

In view of this, novel methods are required to reduce the needed amount of sample DNA, increase data quality, and lower sequencing cost. Although sample DNA can be reduced by means of exponential amplification through Polymerase Chain Reaction (PCR), the amount of data obtainable from PCR amplification targeting one or a few specific genic region is limited, whereas PCR employing a multiplicity of primer pairs incurs high primer cost. In this regard, U.S. Pat. Nos. 5,773,649, 6,060,243 and 7,537,889 describe the use of inter-Alu PCR for the simultaneous amplification of multiple regions in the human genome. Among them, U.S. Pat. No. 5,773,649 has employed inter-Alu PCR to amplify cancer genomic DNA and peripheral blood genomic DNA from the same patient, allowing detection of replication errors in the cancerous DNA sample based on alterations in banded DNA patterns in agarose gel electrophoresis, but the mutations occurred in the altered DNA were not analyzed.

Previous studies have shown that AluY subfamily insertions result in genome instability, which may contribute to a variety of genetic diseases. Thus the vicinities of AluY element insertions in the human genome constitute recombination hotspots of possible importance to disease etiologies. Moreover, Alu elements are estimated to harbor up to 33% of the total number of CpG sites in the human genome, and the level of CpG site methylation is reported to be significantly decreased especially in AluY subfamily sequences. It follows that inter-Alu PCR using AluY consensus sequence-based primers can be utilized to amplify simultaneously a wide range of AluY-vicinal DNA sequences for the efficient detection of SNPs, point mutations, sequence indels and DNA CpG loci methylation of potential significance to disease etiologies, employing only very small amounts of sample DNA and generating quality sequence data from high-throughput sequencing, thereby achieving a desirable balance of low sample size-low cost-high data quality-high data quantity.

### DESCRIPTION OF INVENTION

The present invention involves the detection of genomic region single nucleotide polymorphisms (SNP), point mutations, insertion/deletions (indel) and CpG loci DNA methylation. The method uses inter-Alu PCR in conjunction with massively-parallel sequencing technology for the detection of sequence and structural variations in the genome.

Because Alu elements distributed in primate genomes and tend to accumulate in gene-rich regions, inter-Alu PCR can provide an effective pre-sequencing capture of inter-Alu sequences enriched with genic sequences across the genome. The quality of DNA amplicons obtained from inter-Alu PCR is six times better than direct use of genomic DNA templates in terms of yield of DNA sequences and coverage of genic regions in the genome. This method enables the use of only submicrogram levels of genomic DNA samples for the purpose of massively-parallel sequencing directed to the detection or discovery of genetic variations (SNPs, point mutations, indels and CpG loci DNA methylation).

One embodiment of the present invention exploits the impact of AluY element insertions in causing genomic instabilities and recombination hotspots, where the frequencies of SNPs including possibly disease-associated SNPs are enhanced. By employing inter-Alu PCR with AluY consensus sequence-based primers, DNA sequences in the inter-Alu regions are selectively amplified. Cycles of PCR are performed with thermo-stable DNA polymerase, and DNA replication would be carried out with the addition of free deoxynucleoside triphosphates (A, G, C, T).

Because of the exponential amplification brought about by PCR, only submicrogram quantities of genomic DNA produce enough inter-Alu amplicons for analysis by massively-parallel sequencing. At the same time, due to the structural similarity of different Alu repeat elements and their abundance (accounting for more than 10% of the human genome), use of a single AluY specific primer can generate a range of variously sized PCR amplicons amplified from different regions in the genome, and use of multiple AluY- and other Alu-consensus primers can generate a multitude of such amplicons. Thus, when a single Alu-consensus primer is employed, agarose gel electrophoresis and ethidium bromide staining reveals the PCR amplicons obtained mainly as discrete bands upon UV visualization. When multiple primers are employed, the amplicons become so numerous that they appear as continuous smears on the gel, consisting of a myriad of inter-Alu sequences originating from all kinds of chromosomal locations in the human genome. Since a large number of Alu repeats are located in or near genic regions of the genome, massively-parallel sequencing of the amplicons show that the amplicons come to be enriched up to 40% in genic sequences, even though genic sequences comprise only 25% of the whole genome. Most of the SNPs detected among the amplicons are located in the Alu sequence or its flanking regions. The method therefore provides a useful enriching tool for the monitoring and/or discovery of known and novel genic SNPs and indels in the genome.

Another embodiment of this invention employs the above-stated method to detect genetic variations that are specific to different disease states, especially point mutations and indels occurring in the introns and exons in a cancer genome. There are 25,000 genes in the whole human genome. Among them, as many as 6,522 genes are known to be associated with cancer, accounting for 26% of total number of genes. When the present invention was employed with AluY consensus sequence-based primers to amplify cancer genomic DNA, 58% of the genes found within genic regions in the amplicons were cancer-associated. In the procedure, two AluY specific primers together with the Alu-consensus sequence primer R12A/267 were jointly used as PCR primers. Through the action of thermostable DNA polymerase, the primers would be annealed to the complementary sequences throughout both strands of template genomic DNA forming primer-template hydrids. DNA replication was initiated by the addition of free deoxynucleoside triphosphates (A, G, C, T), yielding a continuous smear of amplicons on the agarose gel electrophoretogram upon UV visualization. The SNPs located on these amplicons amplified inter-Alu regions were then analyzed by massively-parallel sequencing to detect sequence and structural alterations that are potentially associated with cancer.

Another embodiment of the present invention utilizes the above-mentioned method to assess CpG loci DNA methylation in genomic regions. DNA methylation primarily occurs in 5′-CpG-3′ di-deoxynucleotides, in which a methyl group is added to the 5′ position of the cytosine pyrimidine ring (5′C) to form 5′mC. Many 5′mC occur within CpG enriched Alu family repeats. It has been estimated that 33% of the total number of CpG sites are harbored on Alu elements in the human genome. For that reason, a primer pair based on AluY consensus sequence devoid of CpG sites and with different directions of amplification were employed for the inter-Alu PCR. Genomic DNA samples from cancer tissue and peripheral blood (as normal control cells) treated with sodium bisulfite would be used as template DNA in the inter-Alu PCR. The amplified PCR products contained Alu sequences, enriched in CpG sites, and their flanking regions. Such pairs of primers through different orientations in the inter-Alu PCR could give rise to 4 types of DNA amplicons, with respectively tail-to-tail, head-to-head, tail-to-head and head-to-tail orientations of the two primers, thereby achieving expanded amplicon range and facilitating the capture of a myriad of cancer genomic regions likely to harbor methylated CpG sites for massively-parallel sequencing analysis.

It will be readily apparent to one skilled in the art that various substitutions and modifications may be made in the invention disclosed herein without departing from the scope and spirit of the invention.

The term “genic regions” as used herein refers to regions in the genome located within a gene (genetic element) as the molecular unit of heredity. It represents specific DNA sequence carrying genetic information that has a function in the human organism.

The term “purified PCR products” as used herein refers to PCR products generated from inter-Alu PCR and treated with ethanol or other purification kits to remove any excess primers, enzymes, mineral oil, glycerol and salts.

The term “inter-Alu regions” as used herein refers to the DNA sequences, positioned between two Alu elements, that are amplified during inter-Alu PCR. Since Alu elements are widespread in the human genome, inter-Alu regions that come to be PCR amplified in the presence of multiple Alu-consensus sequence-based primers could cover a substantial portion of the entire genome.

The term “quality” as used herein refers to two attributes of the inter-Alu PCR amplicons: the amount of amplicons produced, and the usefulness of their sequence data e.g. the proportion of genic sequences among the PCR products, the average coverage provided by these products over different regions of the genome etc.

The term “amplicons” as used herein refers to the inter-Alu PCR products. In this invention, the PCR products are obtained from the amplification of human genomic DNA using Alu consensus sequence-based primers.

The term “massively-parallel sequencing” as used herein refers to an advanced fluorescent-labeled sequencing technology capable of producing giga-bases of sequence information in a single run.

The term “nanogram level of genomic DNA” as used herein refers to the submicrogram amounts of DNA needed for inter-Alu PCR followed by next generation sequencing.

The term “AluY consensus sequence-based primer” as herein refers to the inter-Alu PCR primers complementary to AluY subfamily consensus sequences, typically 10-20 bases in length.

The term “white bands” as used herein refers to amplicons with discrete ranges of length obtained from inter-Alu PCR, which upon agarose gel electrophoresis, ethidium bromide staining and UV visualization give rise to white banded patterns.

The term “thermo-stable DNA polymerase” as used herein refers to the DNA polymerase used in inter-Alu PCR, which can be Taq polymerase, KOD polymerase or other polymerases used in DNA amplification.

The term “direction of amplification” as used herein refers to the direction of PCR amplification proceeding forward through either the 5′ (head) or 3′ (tail) end of two Alu elements annealed to by an Alu consensus sequence-based primer.

The term “tail-to-tail” as used herein refers to the amplification of the inter-Alu segment between one Alu 3′ end and an adjacent Alu 3′ end.

The term “head-to-head” as used herein refers to the amplification of the inter-Alu segment between one Alu 5′ end and an adjacent Alu 5′ end.

The term “head-to-tail” as used herein refers to the amplification of the inter-Alu segment between one Alu 5′ end and an adjacent Alu 3′ end.

The term “tail-to-head” as used herein refers to the amplification of the inter-Alu segment between one Alu 3′ end and an adjacent Alu 5′ end.

The term “exon capture” as used herein refers to the capture of exons using inter-Alu PCR products as templates.

The term “CpG loci” as used herein refers to sites on DNA with a 5′-CpG-3′ sequence. In mammals, 70% to 80% of CpG cytosines are methylated.

The present invention is directed to the detection of sequence and structural features in genomic regions, enriched in genic regions. The method employs inter-Alu PCR using only a single or a small number of AluY or other Alu consensus sequence-based PCR primers to capture a myriad of genomic sequences, positioned between two Alu elements and enriched in genic sequences, for massively-parallel sequencing. The method is highly economic in terms of the ng range of sample DNA required, and generates a huge range of high-quality amplicons. These amplicons are enriched in genic regions, and can be methodically varied through the employment of different sets of AluY and other Alu consensus sequence-based PCR primers.

One embodiment of the present invention is based on the characteristics of Alu elements especially the AluY subfamily, viz. insertions of these elements are known to contribute to genomic instability and hotspot of recombination events, and enhanced SNP frequencies including disease-associated SNPs have been found in their vicinities. In view of this, primers specific to AluY and Alu consensus sequences are designed. During inter-Alu PCR, such primers will anneal to their complementary template DNA sequences forming primer-template hybrids. Thermo-stable DNA polymerase would synthesize a new DNA strand complementary to the DNA template strand with free deoxynucleotides (A, G, T, C) in the reaction mix. As the target fragments are exponentially amplified by PCR, the PCR products would be of higher quality than the template DNA. At the same time, due to the structural similarity of Alu repeats and its abundance (more than 10%) in the human genome, even a single AluY specific primer can amplify the sequences between adjacent pairs of Alu elements in many parts of the genome. After agarose gel electrophoresis and ethidium bromide staining, the amplicons appear in a banded pattern upon UV visualization. If multiple Alu and/or AluY-based primers are present during the PCR, a smeared gel would be routinely observed upon UV visualization on account of the myriad of different amplicons produced. In this invention, the probability of obtaining amplicons containing a genic sequence is found to be a high as 40%, even though genic regions only comprise 25% of the whole genome. With this combination of small number of PCR primers, requirement for only submicrogram levels of sample DNA, and enrichment of genic regions among amplicons, the present invention combining inter-Alu PCR and massively-parallel sequencing provides a most valuable tool for the monitoring and discovery of genic SNPs and indels in the genome.

Another embodiment of this invention utilizes the methodology to detect genetic variations associated with different diseases, including point mutations and indels occurring in the introns and exons within the cancer genome. There are 25,000 genes in the whole human genome. Out of these, 6,522 genes are found to be associated with cancer, accounting for 26% of total number of genes. When AluY consensus sequence-based primers were applied to amplify cancer genomic DNA, 58% of the genes found in the amplicons were cancer-associated. The SNPs found on the amplicons therefore could be analyzed by next generation sequencing and analyzed for potential association with cancer. The amplicons also can be analyzed using an exon capture technique, as described below in Embodiment 2.

Another embodiment of the present invention utilizes a single run of the method to measure the DNA CpG methylation level at a host of specific CpG sequence sites throughout the genome. By taking advantage of the abundance of CpG sites within repetitive Alu subfamily elements, an AluY-based two-primer set (one head-type and one tail-type) devoid of any CpG sites on their own base sequences are deployed. All G residues on these primers have been replaced by A residues so they will remain complementary to bisulfite-treated AluY sequences where the C residues have been converted chemically to U residues. Using these primers, bisulfite-treated genomic DNA is amplified by inter-Alu PCR to yield upon massively-parallel sequencing of the amplicons either a CpG doublet wherever the C in an original CpG on the template DNA is methylated, or a TpG doublet wherever the C in an original CpG doublet is unmethylated and therefore converted to U by bisulfite. The method can be employed to analyze and compare the DNA methylation status between normal subject/tissue and diseased subject/tissue.

Below are the descriptions of drawings and embodiments of the present invention.

### BRIEF DESCRIPTION OF FIGURES

FIG. 1-4 illustrates Embodiment 1 of the present invention.

FIG. 1 shows an amplicon obtained in Embodiment 1 by the placement of appropriate PCR primers on genomic DNA and performing PCR reaction. The amplicon contains non-genic sequences flanking a genic region containing an SNP site.

FIG. 2 shows an AluY element with a 5′ (head)-half and a 3′ (tail)-half shaded differently, and a poly-A (viz, An) tail. The annealing positions of two AluY consensus primers, viz. AluH-H and AluT-T, on respectively the head and tail portions of the AluY element and the directions of their extension in PCR are also portrayed.

FIG. 3 shows the sequences of two AluY consensus primers. The “tail-to-tail” or “tail-type” amplification primer AluT-T has a 19-base sequence of 5′-AGGCTGAGGCAGGAGAATG-3′ corresponding to base positions 182 to 200 on AluY; while the “head-to-head” or “head-type” amplification primer (AluH-H) has a 21-base sequence of 5′-TGGTCTCGATCTCCTGACCTC-3′ corresponding to base positions 66 to 86 on the AluY. During PCR, the AluT-T primer will be extended by thermostable DNA polymerase in the direction of, and proceeding beyond, the 3′ tail of the AluY element, whereas the AluH-H primer will be extended in the direction of, and proceeding beyond, the 5′ head of the AluY element, as indicated by their respective arrows. Due to the uneven distribution of AluY elements in the genome, each having a 5′ head and a 3′ tail, segments with varying inter-Alu distances between two adjacent Alus will be amplified by inter-Alu PCR.

FIG. 4 shows gel electrophoretograms of amplicons obtained from inter-Alu PCR. Left: banded gel pattern obtained using only the AluT-T primer by itself; Middle: 1 kb DNA markers (from Fermentas, a subsidiary of Thermo Scientific); Right: banded gel pattern obtained using only the AluH-H primer by itself. Both primers gave rise to amplicons ranging from 300 bp to 2 kb in size in inter-Alu PCR. Arrows separate the fragment ranges excised for sequencing.

FIGS. 5-8 illustrate Embodiment 2 of the present invention.

FIG. 5 shows the sequence and location of AluYTL primer on the AluY element. AluYT1 primer has an 18-base sequence of 5′-GAGCGAGACTCCGTCTCA-3′ corresponding to base positions 278 to 295 of the AluY consensus sequence. This primer was employed for the detection of replication errors associated with cancer.

FIG. 6 shows the inter-Alu PCR schemes using three different primers singly or in combination. Part 1: Use of head-type AluH-1H alone can amplify inter-Alu sequences between two adjacent Alu 5′ heads. Parts 2: Use of tail-type AluYT1 or the tail-type Alu consensus primer R12A/267 (5′-AGCGAGACTCCG-3′) alone can amplify inter-Alu sequences between two adjacent Alu 3′ tails. When PCR is conducted in the presence of all three of these primers, head-to-tail and tail-to-head-types of amplification become feasible as well, thereby greatly increasing the variety of amplicons obtained (Parts 3, 4).

FIG. 7 shows gel electrophoretograms of amplicons obtained using the tail-type AluYT1 primer. Each pair of lanes (F, L, G or W) compares the inter-Alu PCR products amplified from paired cancer and control DNAs extracted from respectively glioma tissue and peripheral blood (containing normal white blood cells) of the same patient. F: patient with primary glioma; L: another patient with primary glioma; G: patient with metastatic glioma; W: patient with anaplastic glioma. The right hand lane is 1 kb DNA markers (from Fermentas). Arrows point to visible band difference between glioma and control DNA.

FIG. 8 shows gel electrophoretogram of amplicons obtained from inter-Alu PCR performed in the presence of all three of AluH-H, AluYT1 and R12A/267, yielding a smeared gel pattern rather than a banded gel pattern on account of a vastly increased variety of amplicons in the case of both anaplastic glioma DNA (left lane) and normal peripheral blood DNA (middle lane) from the same patient. Right: 1 kb DNA markers (Fermentas).

FIG. 9-11 illustrate Embodiment 3 of the present invention.

FIG. 9 shows the positions and directions of amplification of the two AluY consensus sequence-based PCR primers CH11 and CT11, which are both 11 bp long, and based on positions 113-123 and 160-170 respectively of the AluY consensus sequence. CH11 is a head-type primer and amplifies towards 5′ direction, whereas CT11 is a tail-type primer and amplifies towards 3′ direction.

FIG. 10 shows the 113-123 bp and 160-170 bp segments of AluY consensus sequence, and the CT11 and CH11 primers. The sequence of CT11 is complementary to the complement segment of 160-170 bp of AluY after the two “C” residues in the complement segment have been replaced by “U”, in keeping with the conversion of all “C” on genomic DNA outside of CpG di-deoxynucleotides to “U” upon bisulfite treatment. Likewise, the sequence of CH11 is complementary to 113-123 bp of AluY after the three “C” residues in 113-123 bp have been replaced by “U”. In both the CT11 and CH11 sequences, all the “A” residues that result in response to the “C” to “U” conversion on genomic DNA are enclosed inside square boxes.

FIG. 11 shows that primer CH11 by itself can generate head-to-head amplification, generating inter-Alu sequences between two AluY 5′ heads (Part 1). CT11 by itself can generate tail-to-tail amplification between two AluY 3′ tails (Part 2). When both CH11 and CT11 are added to the same inter-Alu PCR reaction, head-to-tail and tail-to-head amplifications are also obtained (Parts 3 and 4).

FIG. 12 shows the inter-Alu PCR sequencing outcome of bisulfite treated genomic DNA. Only 3 μg of the inter-Alu PCR amplicons are required for high-throughput next-generation sequencing to detect C-methylations on the bisulfite treated genomic DNA: all originally methylated “C” residues on the bisulfite treated DNA give rise to “C” residues on the amplicon sequences, whereas all originally unmethylated “C” residues on the bisulfite treated DNA give rise to “T” residues on the amplicon sequences. These divergent outcomes arising from methylated and unmethylated “C” is highlighted by the bold-font “C” on the bottom line on the left hand side of the figure, versus the bold-font “T” on the right hand side.

### DETAILED DESCRIPTION OF EMBODIMENTS

### Embodiment 1

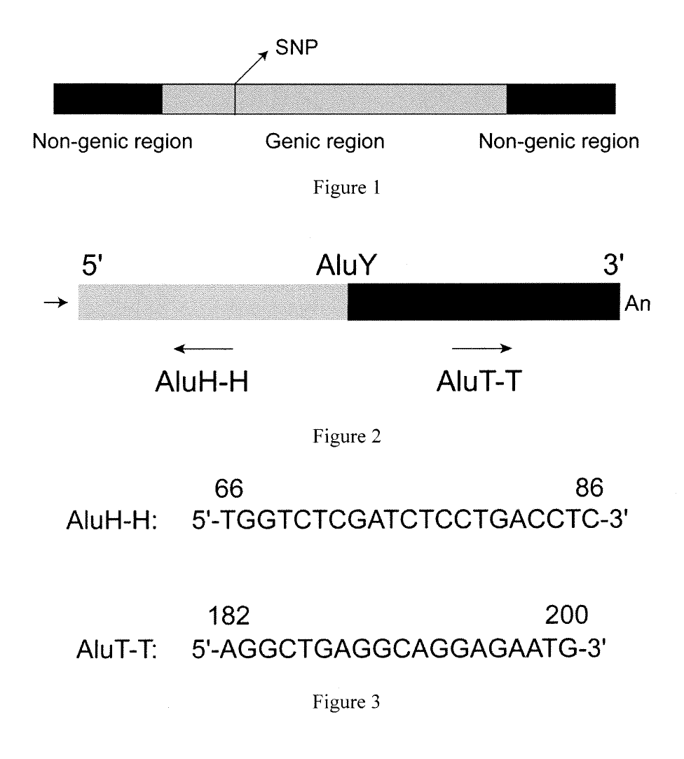

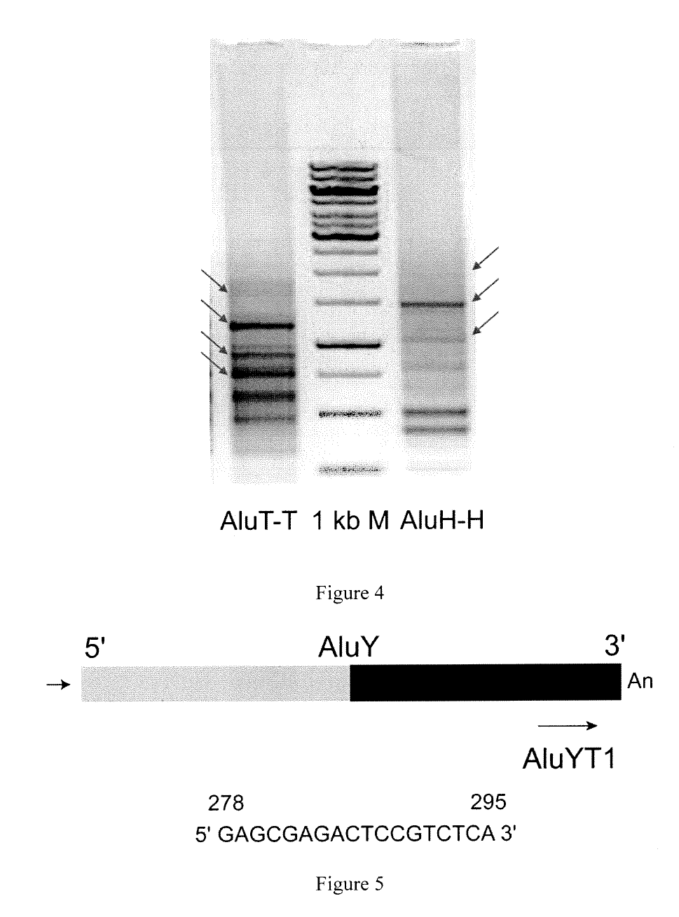

The diagnostic identification of SNPs present in genic regions of the human genome, whether haploidal, homozygous diploid or heterozygous diploid, is illustrated in FIG. 1. To do so, inter-Alu PCR is performed to amplify genomic sequences situated in or close to Alu elements, which are enriched in genic regions. This is followed by next-generation sequencing of the amplicons to reveal the SNPs present in the genic regions among the amplicons. FIG. 2 shows the positions of two AluY consensus primers annealed to an AluY element, and their directions of amplification in PCR. FIG. 3 shows both the sequences of two AluY consensus primers, and their corresponding base positions on AluY. During inter-Alu PCR, These AluY consensus sequence-based primers will anneal to the complementary template sequences on genomic DNA, and undergo chain elongation in the presence of free deoxynucleotide triphosphate A, G, T and C, and a thermo-stable DNA polymerase. Based on the orientation of Alu, one of the primers can amplify the sequence from one Alu 3′ end to another Alu 3′ end (tail-to-tail direction) whereas another primer can amplify the sequence from one Alu 5′ end to another Alu 5′ end (head-to-head direction). In each instance, the amplicons, as observed in the banded electrophoretograms (FIG. 4) will be analyzed by next-generation sequencing to identify the known or novel SNPs in the amplicons. An example illustrating how the present invention cn be employed to capture and identify intra-genic SNPs is given as follows.

The first step is to prepare human genomic DNA using phenol/chloroform extraction, followed by ethanol purification. Purified DNA is diluted to a working concentration, usually 50 ng/μl. Useful AluY consensus sequence-based PCR primers are exemplified by AluT-T, which yields by itself “tail-to-tail” amplification, and AluH-H, which yields by itself “head-to-head” amplification. In the present example, each PCR reaction was performed in a final volume of 20 μl containing 4 μl 5× Mastermix (10×PCR buffer containing 500 mM KCl, 100 mM Tris-Cl, 15 mM MgCl₂), 50 mM MgCl₂ and 2.5 mM of each of dATP, dTTP, dCTP and dGTP, 1 μl 5 μM primer (AluT-T or AluH-H), 0.1 μl (0.5 unit) thermo-stable DNA polymerase, 2 μl 50 ng/μl human genomic DNA and 12.9 μl deionized water. PCR amplification included DNA denaturation at 95° C. for 5 min, followed by 35 cycles each of 30 s at 95° C., 30 s at 66.3° C. for AluH-H (or 66.8° C. for AluT-T) annealing, and 2 min at 72° C., plus finally another 5 min at 72° C. After completion of the PCR reaction, 10 μl PCR products were sampled to check for appearance and quality by agarose gel electrophoresis, ethidium bromide staining and UV visualization. The gel electro-phoretogram of PCR products obtained in each instance is shown in FIG. 4. Comparison of the banded pattern with 1 kb DNA markers indicated that the amplicons ranged from 300 bp to 2 kb in size. Seven amplicon-fractions ranging from 450 bp to 2 kb in size were excised from the two gels (as indicated by arrows in FIG. 4). The quantity of DNA in each fraction was >10 μg. A total of 372 Mb of DNA sequencing data from these seven fractions were obtained from massively-parallel sequencing. The Short Oligonucleotide Analysis Package (SOAPalinger) was employed for oligonucleotide alignment to assemble longer DNA sequence reads, which were then mapped to the reference human genome using BLAST alignment tool and UCSC database for SNP detection and discovery.

Upon sequencing and bioinformatics analysis, the above-mentioned inter-Alu PCR run generated 374 DNA fragments, 153 of them of which were found to contain intra-genic sequences amounting to 40% of total sequencing output. Since genic regions only occupy 25% of the human genome, these results demonstrated that Alu elements preferentially accumulate in genic regions, and the inter-Alu sequences obtained form inter-Alu PCR were enriched in genic sequences. In addition, there are 25,000 genes in the human genome, 6,522 of which (viz. 26% of all genes) are known to be associated with cancer. In the present Embodiment, the genic regions of 128 genes were included in the sequence output. Out of these, 75 of them, or 58% of all the genes in the sequence output, were cancer-associated genes. Therefore the sequence output from the inter-Alu PCR run was enriched in cancer-associated genes relative to all known genes. By means of BLAST and UCSC database, a total of 262 SNPs (including those in non-genic regions) were identified in the sequence output, 42 of them were novel SNPs or point mutations. These results show that using the present invention, analysis of only 100 ng human DNA sample employing only two AluY-based PCR primers sufficed to provide novel and useful intra-genic SNP information.

### Embodiment 2

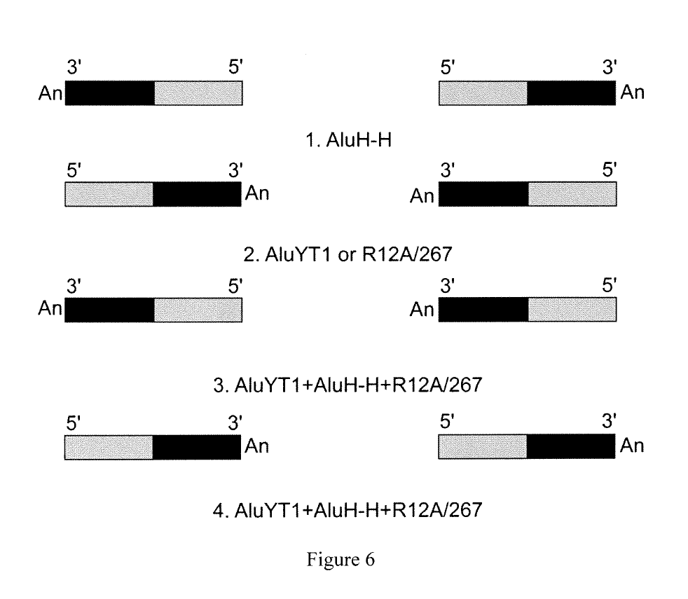

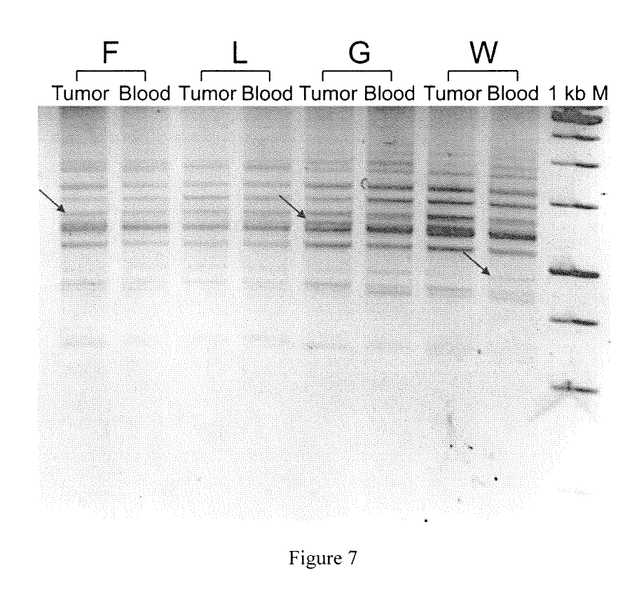

Embodiment 2 was similar to Embodiment 1 except that it was focused on association with multiple-gene diseases. In order to increase amplicon variety to facilitate mutation detection in cancer genome, the tail-type AluYT1 primer (viz. 5′-GAGCGAGACTCCGTCTCA-3′ as shown in FIG. 5) along with the aforementioned head-type AluH-H primer (5′-TGGTCTCGATCTCCTGACCTC-3′) and the tail-type Alu consensus primer R12A/267 (5′-AGCGAGACTCCG-3′) were employed jointly. During inter-Alu PCR, these three primers would anneal to complementary sequence sites on genomic DNA, and participate in PCR amplification. FIG. 6 shows the allowed amplification schemes of these 3 primers employed either alone or in combination. Based on the orientation of Alu, the tail-type AluYT1 or R12A/267 alone is capable of amplifying inter-Alu sequences between two Alu 3′ tails (tail-to-tail amplification), whereas the head-type AluH-H by itself is capable of amplifying inter-Alu sequences between two Alu 5′ heads (head-to-head amplification). When all these three primers are present, amplification of inter-Alu segments spanning one Alu 5′ end to an adjacent Alu 3′ end (head-to-tail) or spanning one Alu 3′ end to an adjacent Alu 5′ end (tail-to-head amplification) are obtained as well. In the present Embodiment, the AluYT1 primer was employed to amplify cancer tissue and control DNA by inter-Alu PCR, so that the size ranges of the amplicons were relatively more restricted, thus giving rise to a banded gel electrophoretogram where changes in the band pattern were more readily detected. On the other hand, AluYT1, AluH-H and R12A/267 were also employed jointly, so that the size ranges of the amplicons were greatly enhanced, giving rise to a smeared gel pattern and enabling the analysis of a vastly expanded number of amplicon sequences by next generation sequencing. These contrasting examples illustrated the flexibility of the present invention in combining inter-Alu PCR and next generation sequencing to detect altered features of the human genome in association with diseases. In the first instance employing only the AluYT1 primer, genomic DNA from cancer and control cells from the same patient was prepared by phenol/chloroform extraction, followed by ethanol purification. Purified DNA was diluted to a working concentration of 50 ng/μl. Inter-Alu PCR was performed in a final volume of 20 μl containing 4 μl 5× Mastermix (10×PCR buffer containing 500 mM KCl, 100 mM Tris-Cl, 15 mM MgCl₂), 50 mM MgCl₂ and 2.5 mM of each of dATP, dTTP, dCTP and dGTP), 1.2 μl 5 μM AluYT1 primer, 0.1 μl thermostable DNA polymerase, 2 μl 50 ng/μl human genomic DNA and 12.7 μl deionized water. PCR amplification included DNA denaturation at 95° C. for 5 min, followed by 35 cycles each of 30 s at 95° C., 30 s at 67° C., and 2 min at 72° C., plus finally another 5 min at 72° C. After completion of the PCR reaction, 20 μl PCR products were taken for electrophoresis on 1.5% agarose gel, ethidium bromide staining and UV visualization. FIG. 7 shows the gel patterns of paired amplicons from cancer tissue and peripheral blood from the same patient. Arrows indicate altered band patterns in patients F, G and W.

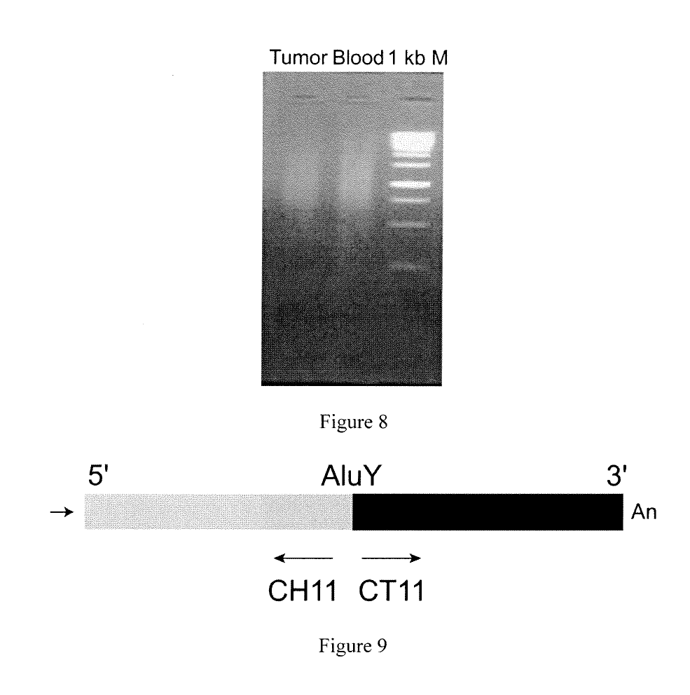

In the second instance employing all three primers, Inter-Alu PCR was performed in a final volume of 20 μl containing 4 μl 5× Mastermix (10×PCR buffer containing 500 mM KCl, 100 mM Tris-Cl, 15 mM MgCl₂), 50 mM MgCl₂ and 2.5 mM of each of dATP, dTTP, dCTP and dGTP), 1.5 μl 5 μM, 0.9 μl 5 μM AluH-H, 0.3 μl 5 μM R12A/267, 0.1 μl thermostable DNA polymerase, 1 μl 10 ng/μl human genomic DNA and 12.2 μl deionized water. PCR amplification included DNA denaturation at 95° C. for 5 min, followed by 35 cycles each of 30 s at 95° C., 30 s at 57.8° C., and 2 min at 72° C., plus finally another 5 min at 72° C. After completion of the PCR reaction, 5 μl PCR product was taken for electrophoresis on 1.5% agarose gel and UV visualization. FIG. 8 shows the smeared gel electrophoretograms of amplicons from either glioma tissue and control pheripheral blood DNA. In this example, 10 ng genomic DNA generated more than 3 μg of amplicons through inter-Alu PCR. Such high yield of amplicons was favorable for massively-parallel sequencing analysis of the amplicons, producing far more genic sequences for association studies compared to using just the AluT1 primer alone. The Short Oligonucleotide Analysis Package (SOAPalinger) was employed to assemble longer DNA sequence reads that were then mapped to the reference human genome using BLAST alignment tool and UCSC database to reveal somatic mutations and indels between cancer and control DNA.

Yet another application of the inter-Alu PCR amplicons described in the preceding paragraph pertains to their usage as a discovery tool in exon capture employing the adenovirus shuttle vector pETV-SD. Any gene containing introns and exons must undergo RNA splicing during transcription, which requires a splicing donor SD and a splicing acceptor SA. The procedure calls for shotgun cloning of the inter-Alu PCR amplicons into pETV-SD downstream from its exon capture sequence. Next, pooled plasmid DNA from the shotgun cloning is transfected into the retroviral packaging cell line ψ2, which provides the proteins required for propagating the vector as a retrovirus. Upon transcription of the retroviral DNA in vivo, transcripts of recombinant plasmids that contain a functional SA could undergo a splicing event with the loss of IVS. Both spliced and non-spliced viral RNAs are then packaged into virions, which after harvesting from the medium are used to infect the retroviral packaging cell line PA-317.

This results in an additional round of retroviral replication and produces viral stocks of increased titer capable of infecting monkey renal COS cells, which constitutively produce the SV40 large tumor (T) antigen. The viral RNA genome is reverse transcribed and amplified as a circular DNA episome due to the presence of the SV40 origin of replication in the vector. The replicated episomal DNA is recovered from the COS cells, digested with Dpn I, and transformed into bacterial cells. Transformants are selected on agar plates containing kanamycin (Kan) and 5-bromo-4-chloro-indolyl-β-D-galactopyranoside (X-gal). Hydrolysis of X-gal by functional β-galactosidase produces the characteristic blue color indicative of a Lac phenotype, whereas colonies that do not contain any functional β-galactosidase are white. Only white colonies are picked for subsequent study. Correct splicing is indicated by the precise removal of the genetically marked IVS and joining of the HBG (human β-globin) exon to the “captured” exon on an inserted fragment. This mode of exon capture coupled with next generation DNA sequencing can usefully identify exonic variants (SNPs, point mutations and indels) associated with a cancer genome. Short Oligonucleotide Analysis Package (SOAPalinger) can be employed for short oligonucleotide alignment to enable their assembly into longer DNA sequence reads capable of being mapped to the reference human genome using BLAST alignment tool together with the UCSC database to reveal sequence differences between tumor and control DNA specifically in their genic regions.

### Embodiment 3

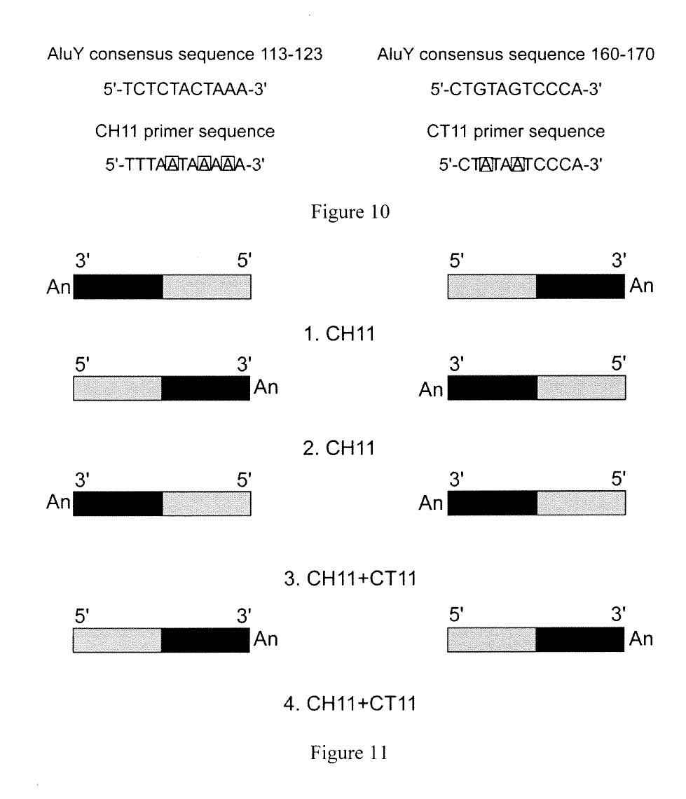

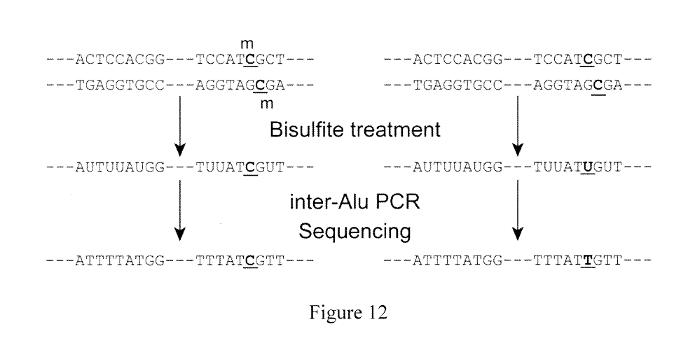

Embodiment 3 illustrates the application of the present invention combining inter-Alu PCR and next generation sequencing to detect CpG methylations. Many 5′mC are found within CpG dinucleotide-enriched Alu family repeats that make up 33% of the total CpG sites in the human genome. Previous studies have shown significant changes in the levels of CpG methylation in specific Alu sequences and their flanking regions in cancer and psychiatric disorders such as schizophrenia. This Embodiment describes the application of the present invention to asse the variation of CpG methylation in diseases. For this purpose, genomic DNA will be pretreated with bisulfite converting all unmethylated “C” including those at CpG sites to “T”. FIGS. 9-11 show two AluY consensus sequence-based PCR primers, viz. CT11 and CH11. CT11 is 11 bp long and a tail-type primer that can by itself in PCR generate inter-Alu sequences from one Alu 3′ tail to another Alu 5′ tail. CH11, also 11 bp long, is a head-type primer that can generate by itself inter-Alu sequences from one Alu 3′ head to another Alu 3′ head. When both CH11 and CT11 are added to the same inter-Alu PCR reaction, inter-Alu sequences from one Alu 5′ head to an adjacent Alu 3′ tail (head-to-tail direction), as well as from one Alu 3′ tail to an adjacent Alu 5′ head (tail-to-head direction) will also be obtained.

Since all unmethylated “C” on the target genomic DNA would be converted to “T” by bisulfite treatment, CH11 and CT11 were designed such that the CT11 sequence corresponded to the complement of 160-170 bp of AluY consensus sequence, with all the “G” residues on the sequence replaced by “A”. Similarly, the CH11 sequence corresponded to the complement of segment 113-123 of AluY consensus sequence, with all the “G” residues converted to “A”.

In the inter-Alu PCR, 900 ng genomic DNA was incubated with 0.3M NaOH at 42° C. for minutes, followed by 95° C. for 3 minutes and 0° C. for 1 minute. The DNA was then treated 2.0 M sodium bisulfite and 0.5 mM hydroquinone, topped with mineral oil and incubated at 55° C. for 16 hours. The bisulfite-treated DNA was purified, and amplified in inter-Alu PCR. Each PCR reaction had a final volume of 20 μl containing 4 μl 5× Mastermix (10×PCR buffer (500 mM KCl, 100 mM Tris-Cl, 15 mM MgCl₂), 50 mM MgCl₂ and 10 mM dNTP mix), 1 μl 5 μM CH11 primer, 1 μl 5 μM CT11 primer, 0.1 μl thermostable DNA polymerase, 2 μl 10 ng/μl bisulfite-treated genomic DNA and 11.9 μl deionized water. PCR amplification included DNA denaturation at 95° C. for 5 min, followed by 20 cycles each of 30 s at 95° C., 30 s at 52° C., and 2 min at 72° C., plus finally another 5 min at 72° C. Because of the difficulty in amplifying bisulfite-treated genomic DNA by PCR, the steps described above were repeated once in order to enhance the quantity of amplicons. After completion of these PCR reactions, 5 μl PCR product were mixed with 50% glycerol, electrophoresed on 1.5% agarose gel, and inspected by UV visualization.

Only 3 μg of the PCR amplified products containing Alu sequences and their flanking regions were required for the next-generation sequencing of the bisulfite treated DNA template sequences, where methylated “C” on the pre-treatment DNA would remain as “C” in the amplicons, whereas unmethylated “C” on the pre-treatment DNA would be converted to “T”. Following the sequencing, Short Oligonucleotide Analysis Package (SOAPalinger) was employed for short oligonucleotide alignment to assemble longer DNA sequence reads. BLAST alignment tool and UCSC database were employed to map these reads to the reference human genome to measure and compare the levels of methylation of CpG at specific sequence sites in tumor and control DNA.

Besides cancer, Embodiment 3 can also be utilized in the measurement of DNA methylation levels at specific genomic CpG sites in a range of genetic diseases.

1. The method for detecting genic region features based on inter-Alu polymerase chain reaction includes the following steps:
(1) Use one or more consensus sequences of Alu family elements as the main oligonucleotide PCR primers to perform inter-Alu PCR amplification of sample DNA;
(2) Carry out high throughput sequencing using cyclic-array sequencing based on synthesis;
(3) Detection of genic region single nucleotide polymorphisms (SNP), point mutations, insertion/deletions and the level of DNA CpG loci methylation in the genome based on the sequencing data.

2. The method of claim 1, wherein the amplified sample DNA comprises DNA segments situated between two adjacent Alu sequences.

3. The method of claim 1, wherein the sample DNA is extracted from tissue or white blood cells in peripheral blood by phenol/chloroform, followed by agarose gel electrophoresis, ethidium bromide staining and extraction of the amplicon DNAs from the gel under visualization by UV.

4. The method of claim 1, wherein the oligonucleotide primers designed on the basis of the AluY consensus sequence include the following sequences: 5′-GAGCGAGACTCCGTCTCA-3′,5′-TGGTCTCGATCTCCTGACCTC-3′ and 5′-TGGTCTCGATCTCCTGACCTC-3′.

5. The method of claim 1, wherein AluY consensus sequence-based primers are used in combination with the Alu consensus sequence-based primer R12A/267 to amplify genic sequences.

6. The method of claim 1, wherein thermostable DNA polymerases are employed for inter-Alu PCR.

7. The method of claim 1, wherein the target DNA is pre-treated with sodium bisulfite for the measurement of CpG methylation level at different CpG sites.

8. The method of claim 7, wherein inter-Alu PCR is performed with two consensus primers (CH11 and CT11), both devoid of CpG sites and located near the central region of the AluY subfamily consensus sequence. CH11 amplifies towards 5′ direction and is 11 bp long with base sequence “5′-TTTAATAAAAA-3′”; CT11 amplifies towards 3′ direction and is 11 bp long with base sequence “5′-AACATCAAAAT-3′”.

9. The method of claim 7, wherein the extent of CpG methylation in bisulfite-treated cancer and normal genomic DNA is compared. Next-generation sequencing technique is employed to measure the level of CpG methylation in CpG-enriched Alu sequences and their flanking regions.

10. The method of claim 7, wherein any AluY or Alu consensus sequences devoid of CpG loci can be utilized as oligonucleotide primers after conversion of “C” to “T”.
